(19) United States
(12) Patent Application Publication
(10) Pub. No.: US 2004/0223470 A1
(43) Pub. Date: Nov. 11, 2004

(54) Systems and methods for dynamic resource allocation

(76) Inventor: Adrian Smith, Bellevue, WA (US)

Correspondence Address: Michael S. Smith, BLACK LOWE & GRAHAM PLLC, Suite 4800, 701 Fifth Avenue, Seattle, WA, 98104, US

(21) Appl. No.: 10/841,152

(22) Filed: May 7, 2004

Related U.S. Application Data
(60) Provisional application No. 60/469,452, filed on May 8, 2003.

(51) Int. Cl. H04Q 7/00

(52) U.S. Cl. 370/332

(57) ABSTRACT

Systems and methods for managing connectivity in a wireless network. The system includes a plurality of wireless access points, a wireless network server, and a client device that is trying to connect to a public or private data network via an access point. The server is coupled to two or more access points. The server provides information about the access points to the client device. The client device determines which one of the access points to communicate with based on the information provided by the server and determined signal strength values.

### PRIORITY CLAIM

This application claims the benefit of U.S. Provisional Application Ser. No. 60/469,452, filed May 8, 2003, the contents of which are hereby incorporated by reference.

### FIELD OF THE INVENTION

This invention relates generally to data communication and, more specifically, to management of wireless data communications.

### BACKGROUND OF THE INVENTION

In the next five years, 802.11 wireless fidelity (Wifi) will proliferate in hotspots, enterprises, small businesses and homes. Many communications devices will contain a variety of 802.11 technologies, various enterprises may have a mix of each Wifi flavor and many users will have multiple 802.11 devices which will need simple connectivity, management, and security.

Enterprise IT departments will have many decisions to make regarding which version of Wifi to support, when and where to deploy each technology, how this affects existing infrastructures (like LANs, routers, PBXs) and which services could be more effectively provided over a commonly managed RF platform.

Today's Wifi deployments are rolled out based on a coverage model—i.e.—it is turned on and it covers what it covers, with many overlapping cells in an uncontrolled environment. From a radio frequency (RF) planning point of view this is done with little regard for any other technologies that might be used in the vicinity and also gives little consideration for future requirements for capacity, differentiated services (e.g., voice over IP (VOIP) or other bandwidth, security, or latency dependent application or services).

In some cases, a user's device may pick up multiple access points, some of which have nothing to do with the company they work for or service they subscribe to. This opens a security hole for anyone to set up a “man in the middle” attack for packet sniffing. From the cellular perspective, the whole system selection piece has been moved from being controlled by the service provider or Enterprise and now left to the user to decide which network to connect to. The problem with this from a scaling point of view is that the user can pick any AP when a better one (and not necessarily the strongest) is available. A better AP means an AP that meets the minimum signal requirements and provides the fastest throughput, has less users on, creates less interference, or provides a preferable service.

These same concerns hold true for other wireless wide area networks (WWAN) and wireless local area networks (WLAN). These networks rely on a user being stationary. Thus, when a user connection with an AP fails due to movement of the user or other causes, the user must reinitiate connection with a new proximate AP.

Therefore, there exists a need for a system that provides load balancing, maintains the maximum quality of service, provides continuous connectivity, or differentiated services.

### SUMMARY OF THE INVENTION

The present invention provides systems and methods for managing connectivity in a wireless network. The system includes a plurality of wireless access points, a wireless network server, and a client device that is trying to connect to a public or private data network via one of the access points. The server is coupled to two or more access points. The server determines at least one communication parameter and sets at least two parameter weight values. The determined communication parameter includes an access point data parameter or a parameter identifying number of client devices presently communicating with the respective access point. The client device receives communication parameters from at least a portion of the two or more access points and determines which one of the access points to communicate with based on the received communication parameters, the weight values, and measured data.

In accordance with further aspects of the invention, the determined at least one communication parameter includes a technical parameter, application service parameter, and a security parameter. The received communication parameters include signal strength of each access point relative to the client device.

In accordance with other aspects of the invention, the wireless data communication network comprises an IP based wireless network. For example, the IP based wireless network may be an 802.11, 4G, 802.20, Ultrawideband, or radio frequency identification (RFID) communication network, or other comparable networks.

In accordance with still further aspects of the invention, the communication parameters received from at least a portion of the two or more access points comprises information regarding the access point associated with the wireless network server 30, and the client device selects the access point that is associated with the wireless network server 30 participating with the system.

The prior art presents that if there were five APs in an office and one was in the boardroom hosting 20 clients with client devices for a meeting, all of the client devices would choose to use the AP in the boardroom, because it produces the strongest signal. With all 20 connected to the same AP they would get terrible service. If on the other hand, the network knew which APs were attached and was able to send this information and rules to the clients, the client could then autonomously choose a different AP perhaps down the corridor. This would then provide load balance across all of the APs that meet the signal strength requirements. This rule set could be dynamic in that the network could monitor traffic per AP, interference and AP signal strength as measured at the clients and reported back and include exception parameter based on quality of service, differentiated service, or security options.

In another aspect of the invention, the network controller could self manage the power output of each AP. Assuming one has a multi AP environment, each AP could perform signal strength measurements on each of it's neighbor APs and the network could tune the channels used, the technology preference sent out on the neighbor rules set (list) and power up or down since each AP is affectively making bi lateral link budget measurements.

Hence, in a multi AP environment, the APs connected to a network controller could broadcast lists of associated neighbors, connection preferences, rules sets, exception lists, and connectivity thresholds. The client device would receive this list, run an algorithm previously defined by the system and associate with the best AP instead of the one with the strongest signal strength that all other client devices are trying to connect to. The network controller would be able to react to various traffic conditions, interference exceptions, and AP outages, applications or services offered, and move client devices around (by changing the weighting factors in the neighbor list) in order to maintain the most optimum usage. The client devices would be monitoring this list in order to dynamically shift onto the best AP to get the fastest service regardless of the AP that the client first found.

### BRIEF DESCRIPTION OF THE DRAWINGS

The preferred and alternative embodiments of the present invention are described in detail below with reference to the following drawings.

FIG. 1 illustrates an exemplary system diagram formed in accordance with an embodiment of the present invention;

FIG. 2 is a block diagram of a wireless network capable client device;

FIG. 3 is a flow diagram illustrating an example process performed by components of the system shown in FIG. 1; and

FIG. 4 is a table illustrating example parameters sent from a server/controller to a client device.

### DETAILED DESCRIPTION OF THE PREFERRED EMBODIMENT

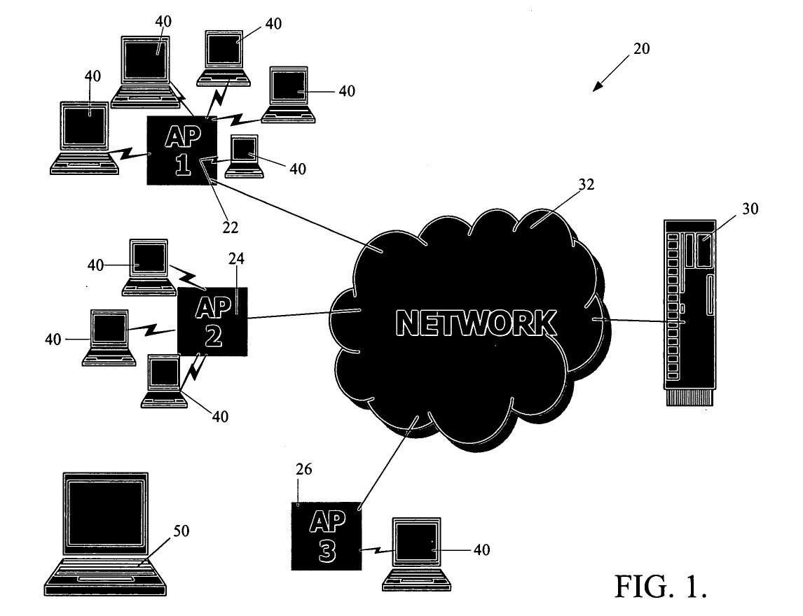

FIG. 1 illustrates an exemplary wireless data communication system 20. The system 20 includes a plurality of access points (APs) 22-26 coupled to a network controller 30 over a public or private data network 32. Each of the APs are presently communicating wirelessly with one or more client computer devices 40. The client computer devices 40 may be any computer device, such as a personal data assistant (PDA), a mobile phone, a laptop or palmtop computer, etc. Another client computer device 50 is not presently connected to any of the APs 22-26. The client device 50 initially makes communication with one of the APs 22-26 to receive information about data communication capabilities of the APs 22-26 from the network controller 30. The network controller 30 receives information periodically from each of the APs 22-26 regarding a certain number of parameters. The parameters are sent from the network controller 30 over the network 32 to the client device 50 via the initial access point that the client device 50 connected to. The client device 50 retrieves information regarding certain parameters related to each of the APs 22-26 and uses that information along with the information received from the network controller 30 to determine which of the three APs 22-26 would be the best to communicate with at the present time. After the client device 50 has made the determination of which is the best AP, the client device 50 switches to that AP, unless the determined AP is the one the client device 50 is already in initial communication with.

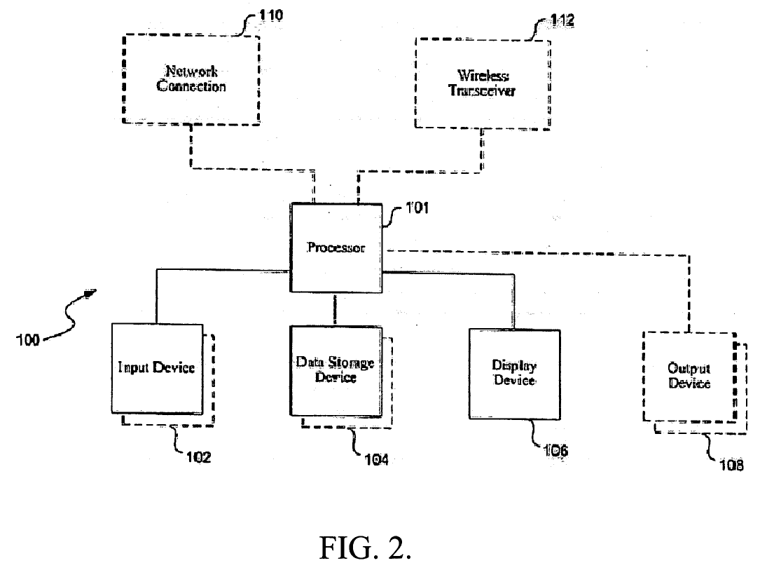

FIG. 2 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or portable computing device. Those skilled in the relevant art will appreciate that the invention can be practiced with other computer system configurations, including personal computers, Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor. As explained below, the invention can be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 2, one embodiment of the invention may run on a computer 100 having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer 100 may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 2).

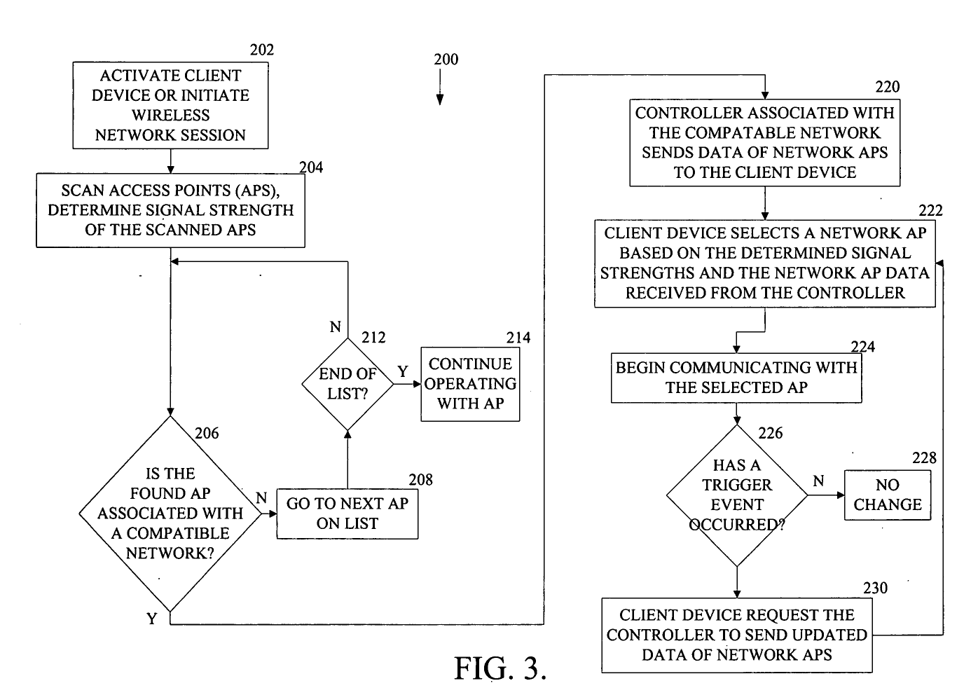

FIG. 3 illustrates a process 200 performed by various components of the system 20 shown in FIG. 1. The process begins when the client device 50 is activated or a wireless network session is initiated at the client device 50, see block 202. At block 204, the client device 50 scans APs, determines the signal strength of the APs, an puts the APs is a list based on the determined signal strength. The list includes basic service set identifier (BSSID) information from all APs that the client device 50 can presently communicate with. At a decision block 206, the client device 50 determines if the AP selected from the list (i.e., on first pass, AP with the strongest signal) is associated with a network 32 or a network controller 30 that the client device 50 either subscribes to or is allowed to communicate with. This accommodates the situation where there are multiple APs belonging to multiple networks or an AP belonging to multiple networks. It can be appreciated that an AP may be shared by multiple controllers 30 that are associated with different networks 32. In a multi-network environment, the client device may also select which network to communicate with. This selection can be based on various parameters, or service or security requirements. If the AP is not associated with the compatible network 32 or controller 30, then, at a block 208, the client device 50 goes down to the next AP on the list and repeats the process performed at the decision block 206 until a compatible AP is found. If, at a decision block 212, the end of the list is reached without finding a compatible AP, then, at a block 214, the client device 50 just performs regular communication with the first selected AP as selected by existing AP selection techniques. After an AP of a suitable network has been found, then, at a block 220, the controller 30 of that network sends data of the APs to the client device 50.

At a block 222, the client device 50 selects one of the APs to communicate with based on the data that it received from the controller 30 and the determined signal strength. The information a client device received directly from the APs associated with the controller 30 may include a signal strength level that client device observes for each AP. At a block 224, the client device 50 begins communication with the selected AP.

At a decision block 226, if a trigger events occurs, then at a block 230, the client device 50 requests the controller to send updated data regarding the network APs and the process returns to the block 222. A trigger event occurs when a parameter or activity goes above or below a predefined trigger threshold. If no trigger event has occurred at the decision block 206, at a block 228, no change in operation occurs. For example, if the signal strength with the active AP drops below a threshold value, the client device would ask for the controller 30 to send an updated parameter set and then analyze the received updated parameter set to determine what AP to connect to. Some example of trigger thresholds include time, signal strength, signal quality, application type, bandwidth allowable, or any parameter or activity determined by the client device 50.

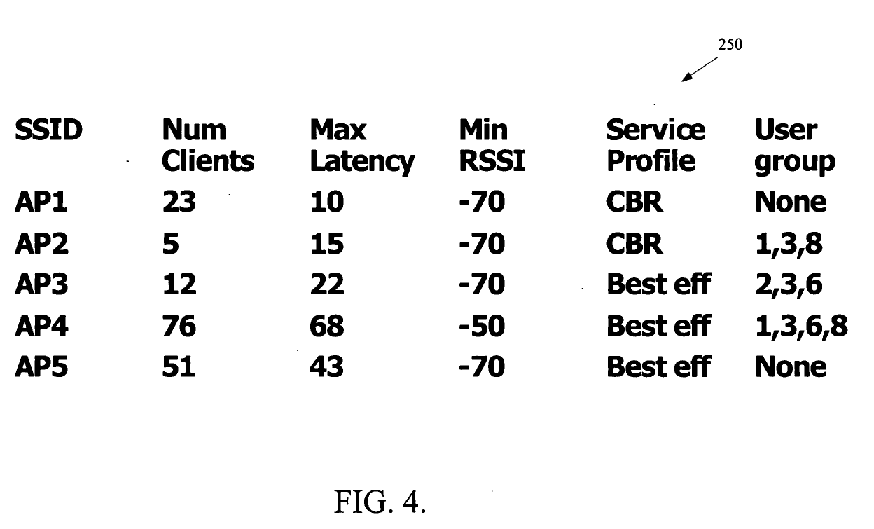

FIG. 4 illustrates an example table 250 that the controller 30 sends to the client device 50. In this example the table 250 includes information about 5 different APs (AP1-5). The information includes the number of client devices 40 it is presently communicating with, maximum latency, minimum received signal strength indication (RSSI), service profile, and preferred user group(s). Maximum latency indicates delay or a measure of data traffic (i.e., bandwidth capability). In this example, service profile information includes CBR (constant bit rate) or best effort bit rate.

With regard to User group, the information in this column indicates what previously defined user groups are preferred at that AP. In this case, each client device would include information about which user group they belong to. For example, project managers may belong to one user group and programmers to another user group.

Included with the information in the table are previously set weight values that are applied to the data in each column by an algorithm/application running on the client device 50. Weight values can also be provided for information that the client device 50 determines or measures from the APs or determines by activity (e.g., signal strength, voice over Internet protocol (VOIP)). The weight values allow a wireless system administrator to emphasize certain parameters over other parameters. Because the weight values can be controlled by the administrator, the administrator has the ability to alter how client devices select an AP. Thus, the administrator has the ability to change access capabilities depending upon various dynamics, such as introduction of new APs (on or off network), short or long term influx of client devices (on or off network), maintenance issues, etc.

The weight values can vary depending upon which AP the client device 50 receives the controller produced information (table).

In this example, the weight value for number of clients is greater than the weight values for latency or signal strength determined by the client device. Thus, if the client device initially connected to AP4 because AP4 had the greatest signal strength, the algorithm with the set weight values might select AP2, because it only has 5 connected client devices even though AP2's latency is higher than AP1's latency. Thus, it can be seen that by altering the weight values one can control allocation of resources.

The following are other parameters or types of parameters that may be included in the information/table sent from the controller 30 or information resident on the client device: physical capabilities; technical capabilities; service capabilities; or security policies. Some example physical capabilities are described above (e.g., number of connected client devices, latency, signal strength, etc.).

An example technical capability includes the type of wireless transmission (e.g. 802.11(a), (b), or (g)). If one of the APs is an 802.11(g) and one is an 802.11(b), it might be desirable to direct (give an increased weight value) to (b) AP for client devices that are (b) devices. This would open up the (g) APs to more (g) client devices.

Some example service capabilities might relate to the application program that the client device is executing and/or what the service capabilities an AP might be designated to support, for example, streaming data, VOIP, or a program that requires a guaranteed bandwidth.

Example security policies information includes whether an AP is behind a firewall, if an AP provides virtual private network (VPN) capabilities, or other security policy information.

In one embodiment, the controller 30 sends an executable program to the client device 50. The executable program remains resident on the client device 50. The program may include instructions to instruct the client device 50 how, when and where to re-evaluate the APs. Thus, the program runs while the client device 50 is connected to the network 32 via an AP. When the executable program determines a trigger event has occurred, the controller 30 either sends a list of numbers that relate to parameter information it received from the APs or the entire executable program can be resent. The program may be in the form of a Java Applet, a server side script, or a Visual Basic (VB).net or script.

While the preferred embodiment of the invention has been illustrated and described, as noted above, many changes can be made without departing from the spirit and scope of the invention. For example, the present invention is not limited to 802.11 wireless communication, but can be applied to other wireless communication, such as Bluetooth, 4G, 802.20, Ultrawideband, radio frequency identification (RFID), etc. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for determining access point communication for a client device 50 in an Internet protocol (IP) based wireless communication network 32, the method comprising:
a. initiating data communication with the wireless data communication network at an access point;
b. determining signal strength of two or more access points associated with a server 30;
c. receiving information about the two or more access points from server 30 via one of the access points;
d. determining which one of the two or more access points to communicate with based on the determined signal strength and the received information; and
e. begin wirelessly communicating with the determined access point.

2. The method of claim 1, wherein the received information includes at least one of technical parameters, application service parameters, and security parameters.

3. The method of claim 2, wherein the received information further includes weight values.

4. The method of claim 3, wherein one or more of the weight values are based on a predefined condition.

5. The method of claim 3, wherein the technical parameters include one or more of number of clients connected, latency, signal strength indication, bandwidth, or preferred capability.

6. The method of claim 3, wherein the application service parameters include information regarding a preferred application program.

7. The method of claim 3, wherein c) is further based on application program activity on the client device 50.

8. The method of claim 1, further comprising:
repeating b-e) if a trigger event occurs.

9. The method of claim 8, wherein the trigger event occurs if at least one of the received information or determined signal strength attains an associated predefined trigger threshold value or action.

10. The method of claim 1, wherein the IP based wireless network 32 is at least one of an 802.11, 4G, 802.20, Ultrawideband, or radio frequency identification (RFID) communication network.

11. A method comprising:
receiving a request from a client device 50 at a server 30 via an access point to initiate communication with an Internet protocol (IP) based wireless communication network;
receiving information for associated access points; and
sending the received information and predefined connectivity information to the client device 50;
wherein the received information includes at least one of technical parameters, application service parameters, and security parameters,
wherein the predefined connectivity information includes weight values associated with the parameters and with one of information determined at the client device 50 or application programs running on the client device 50,
wherein the technical parameters include one or more of number of clients connected, latency, signal strength indication, bandwidth, or preferred capability, and
wherein the application service parameters include information regarding a preferred application program.

12. The method of claim 11, wherein the received communication information includes security information.

13. The method of claim 11, wherein the IP based wireless network is at least one of an 802.11, 4G, 802.20, Ultrawideband, or radio frequency identification (RFID) communication network.

14. A client device 50 comprising:
a means for initiating data communication with an Internet protocol (IP) based wireless communication network at an access point;
a means for determining signal strength of two or more access points associated with a server 30;
a means for receiving information about the two or more access points from server 30 via one of the access points;
a means for determining which one of the two or more access points to communicate with based on the determined signal strength and the received information; and
a means for beginning wirelessly communicating with the determined access point.

15. The device of claim 14, wherein the received information includes at least one of technical parameters, application service parameters, and security parameters.

16. The device of claim 15, wherein the received information further includes weight values.

17. The device of claim 16, wherein one or more of the weight values are based on a predefined condition.

18. The device of claim 16, wherein the technical parameters include one or more of number of clients connected, latency, signal strength indication, bandwidth, or preferred capability.

19. The device of claim 16, wherein the application service parameters include information regarding a preferred application program.

20. The device of claim 16, wherein the means for determining which one of the two or more access points to communicate with is further based on application program activity.

21. The device of claim 14, further comprising:
a means for redetermining which one of the two or more access points to communicate with.

22. The device of claim 21, wherein the means for redetermining occurs if at least one of the received information or determined signal strength attains an associated predefined trigger threshold value or action.

23. The device of claim 14, wherein the IP based wireless network 32 is at least one of an 802.11, 4G, 802.20, Ultrawideband, or radio frequency identification (RFID) communication network.

24. An Internet protocol (IP) based wireless communication network system comprising:
a plurality of wireless access points 22-24;
at least one wireless network server 30, wherein each server being coupled to two or more access points 22-24, the wireless network server 30 comprising:
a first component configured to receive information for associated access points;
a second component configured to set at least two weight values; and
a third component configured to transmit the weight values and the received information,
wherein the received information includes at least one of technical parameters, application service parameters, and security parameters,
wherein the technical parameters include one or more of number of clients connected, latency, signal strength indication, bandwidth, or preferred capability, and
wherein the application service parameters include information regarding a preferred application program.
a client device 50 comprising:
a first component configured to determine signal strength of two or more access points associated with a server 30;
a second component configured to receive the weight values and the information transmitted by the wireless network server 30;
a third component configured to determine which one of the access points to communicate with based on the received weight values and information and the determined signal strength;
a fourth component configured to begin wirelessly communication with the determined access point.

25. The system of claim 24, wherein the technical parameters include one or more of number of clients connected, latency, signal strength indication, or transmission frequency.

26. The system of claim 24, wherein the application service parameters include information regarding a preferred application program.

27. The system of claim 24, wherein the third component of the client device is further based on application program activity.

28. The system of claim 24, wherein the client device further comprises:
a fifth component configured to redetermine which one of the two or more access points to communicate with based on if at least one of the received information or determined signal strength attains an associated predefined trigger threshold value or action.

29. The system of claim 24, wherein the IP based wireless network 32 is at least one of an 802.11, 4G, 802.20, Ultrawideband, or radio frequency identification (RFID) communication network.

30. The system of claim 24, wherein the client device further comprises:
a fifth component configured to select a wireless network server 30 when two or more wireless network servers are present.

31. The system of claim 24, wherein the server further comprises a fourth component configured to transmit an executable program,
wherein the client device comprises a fifth component configured to receive the transmitted executable program,
wherein the third component of the client device determines which one of the access points to communicate with further based on the received executable program.

32. The system of claim 31, wherein the executable program includes at least one of a Java applet, a server side script, or a Visual Basic (VB).net or script.
